(19) United States
(12) Patent Application Publication
(10) Pub. No.: US 2025/0278047 A1
(43) Pub. Date: Sep. 4, 2025

(54) IMAGE FORMING APPARATUS

(71) Applicant: FUJIFILM Business Innovation Corp., Tokyo (JP)

(72) Inventors: Takanari Matsuda, Kanagawa (JP); Satoshi Takada, Kanagawa (JP); Kosuke Maenishi, Kanagawa (JP); Shunki Ogita, Kanagawa (JP); Yoko Matsui, Kanagawa (JP); Chihiro Iijima, Kanagawa (JP)

(73) Assignee: FUJIFILM Business Innovation Corp., Tokyo (JP)

(21) Appl. No.: 18/779,734

(22) Filed: Jul. 22, 2024

(30) Foreign Application Priority Data
Mar. 4, 2024 (JP) 2024-032295

(51) Int. Cl. G03G 15/00; B65H 5/22; G03G 15/16; G03G 15/20

(52) U.S. Cl. CPC G03G 15/5029; B65H 5/224; G03G 15/161; G03G 15/2032; G03G 15/6529; B65H 2406/32

(57) ABSTRACT

An image forming apparatus includes: an image carrier configured to carry an image on a surface of the image carrier; a transfer member configured to come into pressure contact with the image carrier to form a transfer nip and configured to transfer the image on the image carrier onto a paper sheet; a pair of fixing members disposed downstream from the transfer member in a transport path of the paper sheet, configured to come into pressure contact with each other to form a fixing nip, and configured to perform a fixing process on the paper sheet; a transfer change mechanism configured to move at least one of the image carrier and the transfer member to change a pressure contact state between the image carrier and the transfer member; a fixing change mechanism configured to move at least one of the pair of fixing members to change a pressure contact state between the pair of fixing members; and a control unit configured to variably control a transfer nip load at the transfer nip by controlling the transfer change mechanism and variably control a fixing nip load at the fixing nip by controlling the fixing change mechanism. The control unit, before a leading end of the paper sheet enters the fixing nip, increases the transfer nip load from a first transfer nip load to a second transfer nip load larger than the first transfer nip load and decreases the fixing nip load from a first fixing nip load to a second fixing nip load smaller than the first fixing nip load.

### CROSS-REFERENCE TO RELATED APPLICATIONS

This application is based on and claims priority under 35 USC 119 from Japanese Patent Application No. 2024-032295 filed Mar. 4, 2024.

### BACKGROUND

### (i) Technical Field

The present disclosure relates to an image forming apparatus.

### (ii) Related Art

An electrophotographic image forming apparatus has been known. The image forming apparatus includes an image carrier (a transfer belt, a photoconductor drum, or the like) configured to carry an image on the surface thereof, a transfer member configured to come into pressure contact with the image carrier to form a transfer nip and configured to transfer the image on the image carrier onto a paper sheet, and a pair of fixing members disposed downstream from the transfer member in a transport path of the paper sheet, configured to come into pressure contact with each other to form a fixing nip, and configured to perform a fixing process on the paper sheet. Examples of the electrophotographic image forming apparatus are given in Japanese Unexamined Patent Application Publication No. 2013-72908, Japanese Unexamined Patent Application Publication No. 2010-151983, and Japanese Unexamined Patent Application Publication No. 2003-54783.

### SUMMARY

In such an electrophotographic image forming apparatus, when the leading end of the paper sheet enters the fixing nip, the paper sheet may receive an impact, and an image quality defect may thereby occur on a portion of the paper sheet positioned at the transfer nip.

Aspects of non-limiting embodiments of the present disclosure relate to suppressing an image quality defect from occurring, at a timing when the leading end of a paper sheet enters a fixing nip, on a portion of the paper sheet positioned at a transfer nip.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image forming apparatus including: an image carrier configured to carry an image on a surface of the image carrier; a transfer member configured to come into pressure contact with the image carrier to form a transfer nip and configured to transfer the image on the image carrier onto a paper sheet; a pair of fixing members disposed downstream from the transfer member in a transport path of the paper sheet, configured to come into pressure contact with each other to form a fixing nip, and configured to perform a fixing process on the paper sheet; a transfer change mechanism configured to move at least one of the image carrier and the transfer member to change a pressure contact state between the image carrier and the transfer member; a fixing change mechanism configured to move at least one of the pair of fixing members to change a pressure contact state between the pair of fixing members; and a control unit configured to variably control a transfer nip load at the transfer nip by controlling the transfer change mechanism and variably control a fixing nip load at the fixing nip by controlling the fixing change mechanism, in which the control unit, before a leading end of the paper sheet enters the fixing nip, increases the transfer nip load from a first transfer nip load to a second transfer nip load larger than the first transfer nip load and decreases the fixing nip load from a first fixing nip load to a second fixing nip load smaller than the first fixing nip load.

### BRIEF DESCRIPTION OF THE DRAWINGS

Exemplary embodiments of the present disclosure will be described in detail based on the following figures, wherein:

FIG. 1 illustrates an image forming apparatus according to an exemplary embodiment;

FIG. 2 is an enlarged view of a transfer unit and a fixing unit;

FIG. 3 illustrates a flow of control of a transfer nip load and a fixing nip load;

FIG. 4 illustrates the flow of the control of the transfer nip load and the fixing nip load;

FIG. 5 is for illustrating the variable amounts of the transfer nip load and the fixing nip load according to the type of paper sheet;

FIG. 6 is for illustrating image quality improvement according to the amounts of change in the transfer nip load and the fixing nip load; and

FIG. 7 illustrates a flow of control of a transfer nip load, a fixing nip load, and a suction force according to an alternative exemplary embodiment.

### DETAILED DESCRIPTION

Hereinafter, exemplary embodiments according to the present disclosure will be described in detail with reference to the accompanying drawings. The configurations described below are examples for description purposes and can be appropriately changed. In addition, when plural exemplary embodiments, a modification example, and the like are included in the following description, it is assumed from the beginning that features thereof may be used in combination as appropriate. In all the figures, the same or similar elements are denoted by the same references, and redundant descriptions thereof will be omitted.

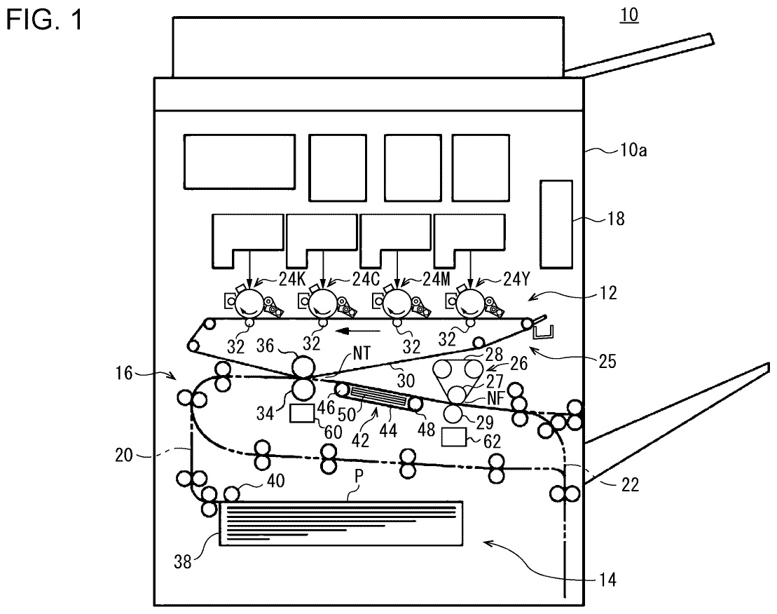

FIG. 1 illustrates an image forming apparatus 10 according to an exemplary embodiment. The image forming apparatus 10 includes an image forming unit 12, an accommodation unit 14, a transport unit 16, and a control device 18.

The image forming unit 12 forms a toner image by employing, for example, an electrophotographic method. The accommodation unit 14 accommodates a paper sheet P that is an example of a recording medium. The transport unit 16 transports the paper sheet P accommodated in the accommodation unit 14 toward the image forming unit 12 along a transport path 20. The transport unit 16 further transports the paper sheet P transported along the transport path 20, along an inversion path 22 to turn the paper sheet P upside down and transports the paper sheet P again toward the image forming unit 12.

The toner image formed by the image forming unit 12 is formed on the front side of the paper sheet P transported along the transport path 20. The paper sheet P on which the toner image has been formed is discharged outside a housing 10a of the image forming apparatus 10.

When a toner image is formed on the back side of the paper sheet P, the paper sheet P having the front side on which the toner image has been formed is transported along the inversion path 22, and a toner image is again formed on the back side of the paper sheet P by the image forming unit 12. The paper sheet P is then discharged outside the housing 10a. Note that, in the example illustrated in FIG. 1, the image forming apparatus 10 has a function of forming toner images on both sides of a paper sheet P but may have a function of forming a toner image only on one side of a paper sheet P.

The image forming unit 12 includes, in one example, image forming parts 24Y, 24M, 24C, and 24K, a transfer device 25, and a fixing device 26. The image forming part 24Y forms a yellow (Y) toner image with a yellow (Y) toner. The image forming part 24M forms a magenta (M) toner image with a magenta (M) toner. The image forming part 24C forms a cyan (C) toner image with a cyan (C) toner. The image forming part 24K forms a black (K) toner image with a black (K) toner. The transfer device 25 transfers the toner images formed by the respective image forming parts 24Y, 24M, 24C, and 24K onto a paper sheet P. The fixing device 26 fixes the toner images transferred onto the paper sheet P by the transfer device 25, to the paper sheet P. Although toners of four colors are used in the example illustrated in FIG. 1, this is merely one example, and toners of five or more colors may be used. For example, in addition to yellow, magenta, cyan, and black, a special color other than the above colors may be used. In another example, only a black toner may be used.

The image forming parts 24Y, 24M, 24C, and 24K have fundamentally the same configuration except for toner to be used. For example, each of the image forming parts 24Y, 24M, 24C, and 24K includes a photoconductor drum being rotatable and having a cylindrical shape, a charger configured to charge the photoconductor drum, an exposure device, and a developing device. The exposure device forms an electrostatic latent image by irradiating the charged photoconductor drum with light. The developing device develops the electrostatic latent image into a toner image with a developer containing a toner.

The transfer device 25 includes a transfer belt 30, first transfer rollers 32, a second transfer roller 34, and a roller 36. The transfer belt 30 is wound around plural rollers including the roller 36 and rotates in the direction of the arrow in FIG. 1. A second transfer portion NT (i.e., a transfer nip) for transferring a toner image onto a paper sheet P is formed between the second transfer roller 34 and the transfer belt 30. Hereinafter, the second transfer portion NT is referred to simply as a transfer portion NT.

The fixing device 26 is disposed downstream from the transfer portion NT in the transport direction of the paper sheet P. The fixing device 26 includes a fixing roller 27, a pressure roller 29, and a fixing belt 28. The fixing roller 27 and the pressure roller 29 are each a cylindrical roller and are each attached to a rotating shaft so as to be rotatable. The fixing belt 28 is wound around the fixing roller 27 and other rollers. The fixing roller 27 is rotated by a motor (not illustrated). In addition, the fixing roller 27 includes thereinside a heater such as a halogen lamp and heats the paper sheet P with the fixing belt 28 therebetween. The pressure roller 29 is disposed at a position where the pressure roller 29 faces the fixing roller 27 with the transport path of the paper sheet P therebetween. The pressure roller 29 is pressed against the fixing roller 27 with the fixing belt 28 therebetween by an elastic member such as a spring. Thus, the pressure roller 29 presses the paper sheet P toward the fixing roller 27. A fixing portion NF (i.e., a fixing nip) for fixing the toner image to the paper sheet P is formed between the fixing belt 28 and the pressure roller 29. The paper sheet P transported to the fixing portion NF is heated by the fixing roller 27 with the fixing belt 28 therebetween and is pressed toward the fixing belt 28 (the fixing roller 27) by the pressure roller 29. Thus, the toner image is fixed to the paper sheet P. Note that the fixing device 26 may be configured without the fixing belt 28, and a fixing portion NF may be formed between the fixing roller 27 and the pressure roller 29 to fix a toner image to a paper sheet P.

The accommodation unit 14 includes an accommodation member 38 and a feed roller 40. The accommodation member 38 accommodates a paper sheet P. The feed roller 40 feeds the paper sheet P accommodated in the accommodation member 38 to the transport path 20.

The transport unit 16 includes plural transport rollers and a transport device 42. The paper sheet P fed from the accommodation unit 14 is transported along the transport path 20 by the plural transport rollers. The transport device 42 is disposed downstream from the transfer portion NT and upstream from the fixing portion NF in the transport direction of the paper sheet. The transport device 42, while sucking, transports the paper sheet P onto which a toner image has been transferred, to the fixing device 26.

The transport device 42 includes a transport belt 44, a support roller 46, a driving roller 48, and a suction mechanism 50. The transport belt 44 is a belt for transporting a paper sheet P. The transport belt 44 is wound around the support roller 46 and the driving roller 48. The support roller 46 is a cylindrical member and is attached to a rotating shaft so as to be rotatable. The support roller 46 is disposed closer to the transfer portion NT than (i.e., upstream from) the suction mechanism 50. The driving roller 48 is a cylindrical member, is attached to a rotating shaft, and can be rotated by the rotating shaft being driven by a motor (not illustrated). The driving roller 48 is disposed closer to the fixing device 26 than (i.e., downstream from) the suction mechanism 50. The transport belt 44 is an endless belt. The transport belt 44 has plural holes passing through from the inner side to the outer side thereof. The suction mechanism 50 generates a negative pressure by sucking air, on the inner side relative to the transport belt 44 For example, a suction fan is disposed inside the suction mechanism 50. As the suction fan operates, the suction mechanism 50 sucks the air above the transport belt 44 through the plural holes in the transport belt 44. Thus, a paper sheet P is attracted to the transport belt 44. When the driving roller 48 is rotated, the transport belt 44 rotates so as to transport a paper sheet P from the transfer portion NT to the fixing portion NF. In addition, the suction mechanism 50 sucks the air above the transport belt 44, and the paper sheet P is thus transported from the transfer portion NT to the fixing portion NF while being attracted to the transport belt 44. Note that the transport belt 44 is an example of a transport member.

The control device 18 controls each of the units of the image forming apparatus 10. The control device 18 is a controller including a processor. The control device 18 is an example of a control unit.

According to the image forming apparatus 10, an image is formed on a paper sheet P as described below.

First, in each of the image forming parts 24Y, 24M, 24C, and 24K, a surface of the photoconductor drum is charged by the charger and is exposed to light by the exposure device to form an electrostatic latent image, and the electrostatic latent image is developed by the developing device. Thus, a toner image is formed on the surface of the photoconductor drum. The toner images in the respective colors are sequentially transferred onto the transfer belt 30 by the first transfer rollers 32.

A paper sheet P is fed from the accommodation member 38 to the transport path 20 by the feed roller 40 and is fed to the transfer portion NT along the transport path 20. At the transfer portion NT, the paper sheet P is transported to a spot between the transfer belt 30 and the second transfer roller 34, and the toner images transferred onto the transfer belt 30 are thereby transferred onto the front side of the paper sheet P.

The paper sheet P onto which the toner images have been transferred is transported to the fixing device 26 by the transport device 42. The toner images transferred onto the front side of the paper sheet P is fixed to the paper sheet P by the fixing device 26. The paper sheet P to which the toner images have been fixed is discharged outside the housing 10a.

In a case of forming a toner image also on the back side of the paper sheet P, the transport unit 16 transports the paper sheet P having passed through the fixing device 26, along the inversion path 22 to turn the paper sheet P upside down and transports the turned-over paper sheet P along the transport path 20 to the transfer portion NT. A toner image is transferred also onto the back side of the paper sheet P at the transfer portion NT and is fixed to the paper sheet P by the fixing device 26. The paper sheet P to which the toner image has been fixed is discharged to the outside from the housing 10a.

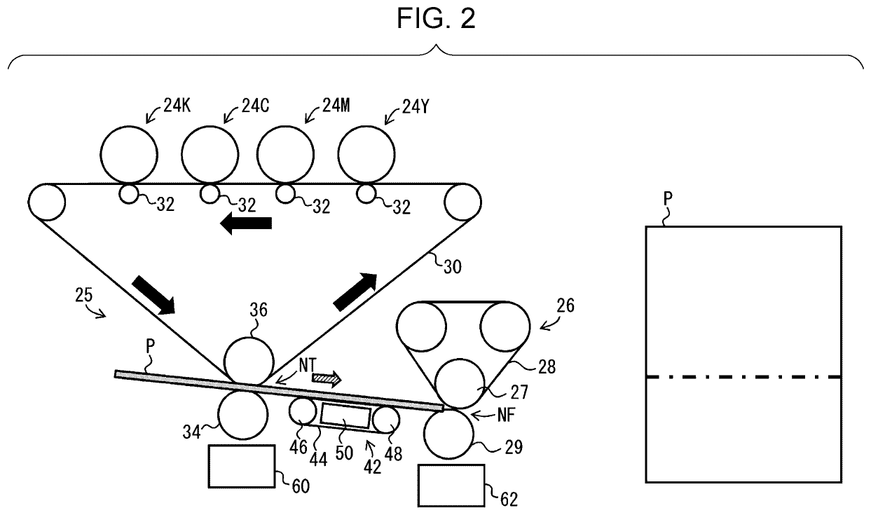

FIG. 2 is an enlarged view of the transfer portion NT and the fixing portion NF and illustrates the transfer device 25 in a simplified manner. The image forming apparatus 10 includes a transfer change mechanism 60 and a fixing change mechanism 62.

The transfer change mechanism 60 is a mechanism configured to move the second transfer roller 34 to change a pressure contact state between the second transfer roller 34 and the transfer belt 30. Note that the transfer change mechanism 60 may change the pressure contact state between the second transfer roller 34 and the transfer belt 30 by moving the transfer belt 30 by moving the roller 36. Further, both the second transfer roller 34 and the transfer belt 30 (the roller 36) may be moved to change the pressure contact state between the second transfer roller 34 and the transfer belt 30. The transfer change mechanism 60 may be implemented by a publicly known technique. The control device 18 variably controls a transfer nip load at the transfer nip NT by controlling the transfer change mechanism 60. The transfer nip load is a load to be applied to a paper sheet P at the transfer nip NT.

The fixing change mechanism 62 is a mechanism configured to move the pressure roller 29 to change a pressure contact state between the pressure roller 29 and the fixing belt 28. Note that the fixing change mechanism 62 may change the pressure contact state between the pressure roller 29 and the fixing belt 28 by moving the fixing belt 28 by moving the fixing roller 27. Further, both the pressure roller 29 and the fixing belt 28 (the fixing roller 27) may be moved to change the pressure contact state between the pressure roller 29 and the fixing belt 28. The fixing change mechanism 62 may be implemented by a publicly known technique. The control device 18 variably controls a fixing nip load at the fixing nip NF by controlling the fixing change mechanism 62. The fixing nip load is a load to be applied to a paper sheet P at the fixing nip NF.

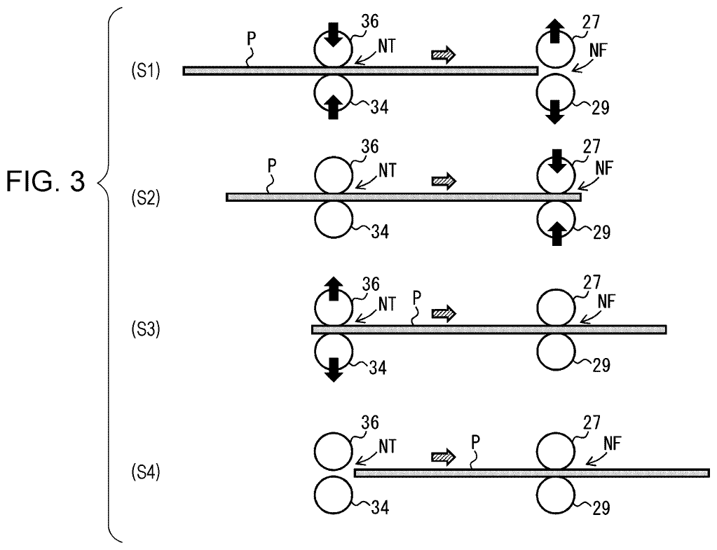

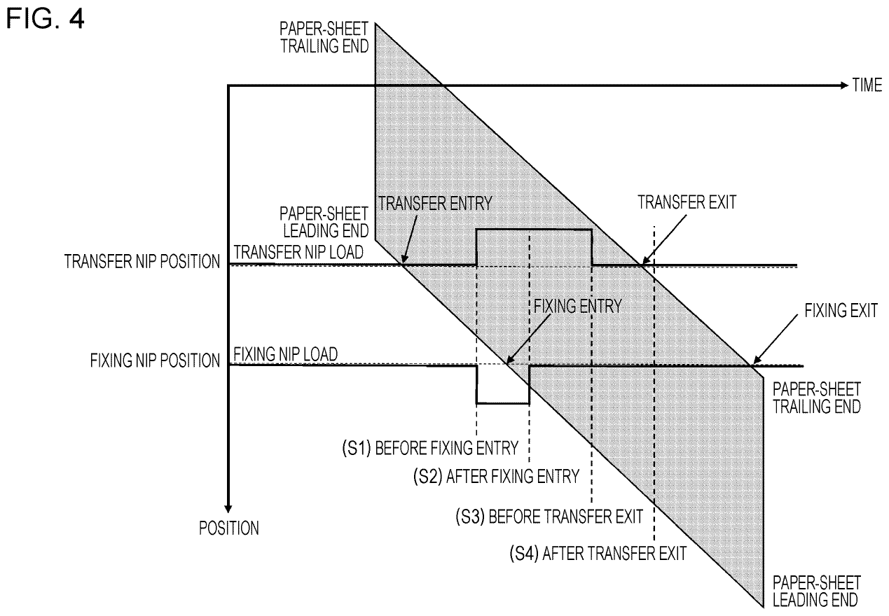

FIGS. 3 and 4 are for illustrating a flow of control of the transfer nip load and the fixing nip load. FIG. 4 illustrates the position change of a paper sheet and changes in transfer nip load and fixing nip load with the lapse of time, with the horizontal axis representing “time” and the vertical axis representing “position”. FIGS. 3 and 4 illustrate the following steps S1 to S4.

Step S1 is a stage during which a paper sheet P is passing through the transfer nip NT and before the leading end of the paper sheet P enters (moves into) the fixing nip NF.

Step S2 is a stage after the leading end of the paper sheet P enters the fixing nip NF.

Step S3 is a stage before the trailing end of the paper sheet P exits the transfer nip NT.

Step S4 is a stage after the trailing end of the paper sheet P exits the transfer nip NT.

In step S1, the control device 18 controls the fixing change mechanism 62 to decrease the fixing nip load. Specifically, the control device 18 decreases the fixing nip load from a first fixing nip load to a second fixing nip load smaller than the first fixing nip load. Thus, the reaction force and the speed variation of the paper sheet at the timing when the leading end of the paper sheet enters the fixing nip NF are reduced.

Further, in step S1, the control device 18 controls the transfer change mechanism 60 to increase the transfer nip load. Specifically, the control device 18 increases the transfer nip load from a first transfer nip load to a second transfer nip load larger than the first transfer nip load. Thus, the paper sheet and the transfer belt can be suppressed from slipping on each other at the transfer nip NT at the timing when the leading end of the paper sheet enters the fixing nip NF.

In the above-described way, in step S1, the control device 18 changes the transfer nip load and the fixing nip load, thereby suppressing an image quality defect from occurring on a portion of the paper sheet P positioned at the transfer nip NT at the timing when the leading end of the paper sheet P enters the fixing nip NF. In a figure on the right in FIG. 2 (a figure illustrating the paper sheet P viewed from above), a smear that may occur on the portion of the paper sheet P positioned at the transfer nip NT is schematically illustrated by a dash-dot line. This smear is caused by the instantaneous deceleration of the paper sheet P when the leading end of the paper sheet P enters the fixing nip NF, and is also called impulse banding (or fixing entry impulse). According to the present exemplary embodiment, the fixing nip load is decreased and the transfer nip load is increased in step S1, thereby suppressing the smear from occurring. Since the nip-load changeable range is narrow when only the fixing nip load or only the transfer nip load is changed, the potential for improvement in an image quality defect may be limited. However, an effective improvement in an image quality defect can be expected by changing both the fixing nip load and the transfer nip load as in the present exemplary embodiment.

Note that, in step S1, the timing when the fixing nip load is decreased and the timing when the transfer nip load is increased may be simultaneous or are not necessarily simultaneous. Further, in a case where the timings are not simultaneous, any one of the decreasing timing of the fixing nip load and the increasing timing of the transfer nip load may be earlier. Note that the expression “increase the transfer nip load . . . and decrease the fixing nip load . . . ” includes both a case where such increase and decrease are performed at the same timing and a case where the increase and decrease are performed at different timings.

In step S2, the control device 18 returns the fixing nip load to the load required for a fixing process, after the leading end of the paper sheet P enters the fixing nip NF. Specifically, the control device 18 increases the fixing nip load from the second fixing nip load to the first fixing nip load larger than the second fixing nip load. At this time, the control device 18 causes the transfer nip load to remain increased, that is, maintains the transfer nip load at the second transfer nip load (a relatively high load).

In step S3, the control device 18 decreases the transfer nip load before the trailing end of the paper sheet P exits the transfer nip NT. Specifically, the control device 18 decreases the transfer nip load from the second transfer nip load to the first transfer nip load smaller than the second transfer nip load. The driving torque of the transfer belt 30 (refer to FIG. 2) is high while the paper sheet P is passing through the transfer nip NT, and the driving torque becomes low after the trailing end of the paper sheet P exits the transfer nip NT. The amount of change in the driving torque increases as the transfer nip load increases. When the trailing end of the paper sheet P exits the transfer nip NT while the transfer nip load remains high, the driving torque greatly changes, and the transfer belt 30 rotates faster. Thus, an image defect may occur on a portion of each of the photoconductor drums of the image forming parts 24Y, 24M, 24C, and 24K (refer to FIG. 2) in contact with the transfer belt 30, that is, a portion performing the first transfer. Eventually, a defect may occur in the toner images on the transfer belt 30, and an image defect may thus occur on a succeeding paper sheet P onto which the toner images are to be transferred at the transfer portion NT (the second transfer portion). However, in the present exemplary embodiment, as described above, the transfer nip load is decreased before the paper sheet P exits the transfer nip NT; thus, the load variation (driving torque variation) when the paper sheet P exits the transfer nip NT is reduced, and the speed variation of the transfer belt 30 is suppressed. Therefore, an image quality defect can be suppressed from occurring on the succeeding paper sheet P.

Step S4 is a stage after the trailing end of the paper sheet P exits the transfer nip NT.

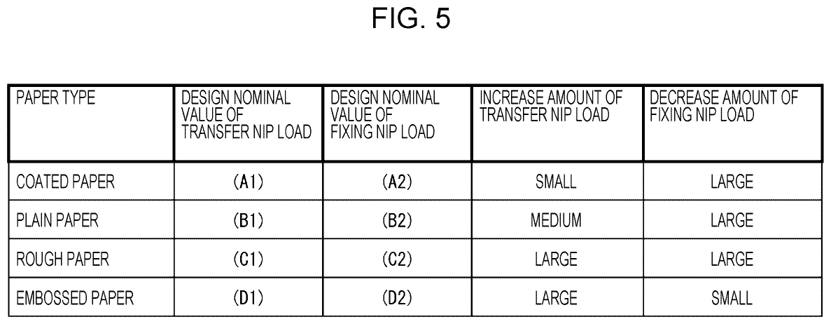

FIG. 5 is for illustrating the variable amounts of the transfer nip load and the fixing nip load according to the type of paper sheet. The control device 18 may change the decrease amount of the fixing nip load and the increase amount of the transfer nip load in step S1 based on the type of paper sheet to be printed. The control device 18 includes a storage, and a table as illustrated in FIG. 5 is stored in the storage. In the table, for example, a type of paper sheet or identification information of paper sheet, a design nominal value of the transfer nip load, a design nominal value of the fixing nip load, an increase amount of the transfer nip load, and a decrease amount of the fixing nip load are associated with one another. The design nominal value represents a normal load before the load is increased or decreased. Note that, in FIG. 5, symbols (A1), (A2), . . . , and (D2) are written in the columns for the design nominal values instead of specific numerical values, and relative magnitudes are written in the columns for the increase amount of the transfer nip load and the decrease amount of the fixing nip load instead of specific numerical values. Note that the paper types illustrated in FIG. 5 are examples.

The control device 18 may obtain the information of a paper sheet to be printed and may obtain and use, from the table, the design nominal value of the transfer nip load, the design nominal value of the fixing nip load, the increase amount of the transfer nip load, and the decrease amount of the fixing nip load that are associated with the paper sheet to be printed, to set the transfer nip load and the fixing nip load in step S1.

Here, since coated paper has a coated surface, toner is likely to scatter on the surface of the paper sheet when the transfer nip load is increased. Thus, when the paper sheet to be printed is coated paper, the control device 18 may decrease the increase amount of the transfer nip load in step S1, compared with a case of not being coated paper. Further, in this case, the control device 18 may increase the decrease amount of the fixing nip load by the amount by which the increase amount of the transfer nip load is decreased.

In addition, since embossed paper has an embossed surface, the design nominal value of the fixing nip load is relatively high in order to prevent a fixing failure. In printing on such embossed paper, if the fixing nip load is greatly decreased before the leading end of the paper sheet enters the fixing nip NF, there is an increase in the amount of movement by which the fixing nip load is returned after the leading end of the paper sheet enters the fixing nip NF, and there is a concern that, for example, a fixing failure may occur near the leading end of the paper sheet. Thus, when the paper sheet to be printed is embossed paper, the control device 18 may decrease the decrease amount of the fixing nip load in step S1, compared with a case of not being embossed paper. Further, in this case, the control device 18 may increase the increase amount of the transfer nip load by the amount by which the decrease amount of the fixing nip load is decreased.

Note that some image forming apparatuses 10 are provided with a gloss mode in which printing is performed with a high fixing nip load regardless of the type of paper sheet to be printed. Even in the printing in the gloss mode, as with the printing of embossed paper, if the fixing nip load is greatly decreased before the leading end of the paper sheet enters the fixing nip NF, there is an increase in the amount of movement by which the fixing nip load is returned after the leading end of the paper sheet enters the fixing nip NF. Thus, in a case where printing is executed in the gloss mode, the control device 18 may decrease the decrease amount of the fixing nip load in step S1, compared with a case where printing is executed in a mode other than the gloss mode (referred to as a normal mode). Further, in this case, the control device 18 may increase the increase amount of the transfer nip load by the amount by which the decrease amount of the fixing nip load is decreased.

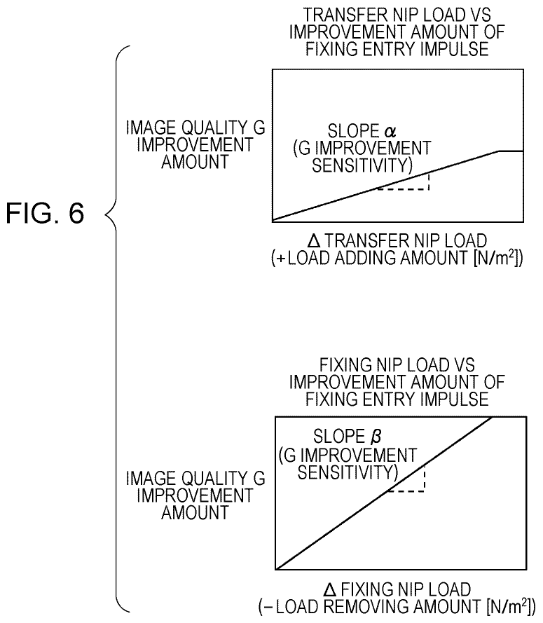

FIG. 6 is for illustrating image quality improvement according to the amounts of change in the transfer nip load and the fixing nip load. The figure relates to an image quality defect occurring on a portion (hereinafter, referred to as a target portion) of a paper sheet positioned at the transfer nip NT at the timing when the leading end of the paper sheet enters the fixing nip NF. The upper part of FIG. 6 illustrates a schematic graph with the horizontal axis representing “increase amount of transfer nip load” and the vertical axis representing “improvement amount of image quality of target portion”. This graph is obtained by, for example, while the transfer nip load is sequentially changed, associating a transfer nip load with the improvement amount of the image quality of the target portion of the paper sheet printed with the transfer nip load (for example, the improvement amount of the image quality detected through visual inspection or by an apparatus). A slope α is obtained from the graph, and the slope a represents the image-quality improvement sensitivity of the target portion.

Further, the lower part of FIG. 6 illustrates a schematic graph with the horizontal axis representing “decrease amount of fixing nip load” and the vertical axis representing “improvement amount of image quality of target portion”. This graph is obtained by, for example, while the fixing nip load is sequentially changed, associating a fixing nip load with the improvement amount of the image quality of the target portion of the paper sheet printed with the fixing nip load (for example, the improvement amount of the image quality detected through visual inspection or by an apparatus). A slope β is obtained from the graph, and the slope β represents the image-quality improvement sensitivity of the target portion.

The image-quality improvement sensitivities α and β may be obtained from the graphs as illustrated in FIG. 6 and may be used to determine the “increase amount of transfer nip load” and the “decrease amount of fixing nip load”. Specifically, the “increase amount of transfer nip load (written as Δtransfer nip load)” and the “decrease amount of fixing nip load (written as Δfixing nip load)” may be determined by the following expression.

$$Target Improvement G < α \times Δ Transfer Nip Load + β \times Δ Fixing Nip Load \qquad ( 1 )$$

For example, when G5 is the image quality of the target portion in a case where the increase of the transfer nip load and the decrease of the fixing nip load are not performed before the leading end of the paper sheet enters the fixing nip NF, and G2 is a target image quality of the target portion, there is required as much improvement as G5−G2=G3. Note that G2, G3, and G5 represent the levels of image quality. Thus, the following expression is established.

$$G 3 < α \times Δ Transfer Nip Load + β \times Δ Fixing Nip Load \qquad ( 2 )$$

Such above expressions may be used to determine the “increase amount of transfer nip load” and the “decrease amount of fixing nip load”. Note that, as described with reference to FIG. 5, since the increase amount of the transfer nip load or the decrease amount of the fixing nip load is limited in the cases of coated paper, embossed paper, and other paper, selectable “increase amount of transfer nip load” and “decrease amount of fixing nip load” vary depending on paper type or a traveling mode (such as the gloss mode or the normal mode). Thus, the “increase amount of transfer nip load” and the “decrease amount of fixing nip load” may be determined in consideration of the above-described factors, and the table as given in FIG. 5 may be created.

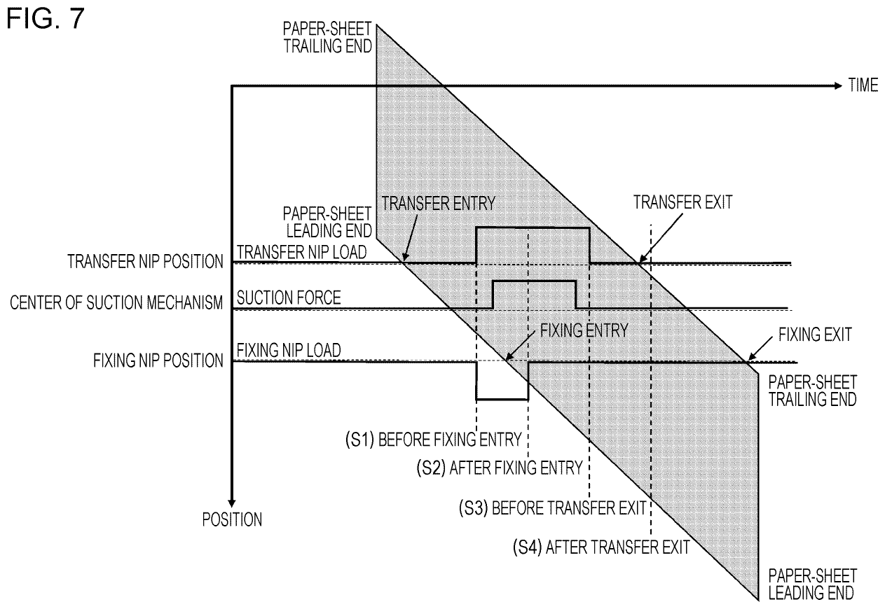

Next, an alternative exemplary embodiment will be described. FIG. 7 illustrates a flow of control of a transfer nip load, a fixing nip load, and a suction force according to the alternative exemplary embodiment. FIG. 7 corresponds to FIG. 4. In the alternative exemplary embodiment, the suction force of the suction mechanism 50 of the transport device 42 (refer to FIG. 2) is changed in addition to the changes in the transfer nip load and the fixing nip load in the above-described exemplary embodiment.

As illustrated in FIG. 7, in step S1, at a stage before the leading end of a paper sheet enters the fixing nip NF, the control device 18 increases the suction force of the suction mechanism 50 of the transport device 42 from a first suction force to a second suction force larger than the first suction force. Thus, the paper sheet comes into closer contact with the transport belt 44. By increasing the suction force of the suction mechanism 50 in this way in addition to the decrease in the fixing nip load and the increase in the transfer nip load, an image quality defect is further suppressed from occurring on a portion of the paper sheet positioned at the transfer nip NT at the timing when the leading end of the paper sheet enters the fixing nip NF.

Note that, in step S1, the timing when the suction force of the suction mechanism 50 is increased may be simultaneous with the timing when the fixing nip load is decreased or the timing when the transfer nip load is increased, or is not necessarily simultaneous therewith. Further, in a case of not being simultaneous, any one of the timings may be earlier.

In addition, in step S2, the control device 18 decreases the suction force of the suction mechanism 50 of the transport device 42 from the second suction force to the first suction force smaller than the second suction force after the leading end of the paper sheet enters the fixing nip NF. Thus, after the leading end of the paper sheet enters the fixing nip, the suction force of the suction mechanism 50 becomes relatively small, and the paper sheet is thus easily transported. Note that the timing when the suction force of the suction mechanism 50 is decreased may be simultaneous with the timing when the fixing nip load is increased, or is not necessarily simultaneous therewith. Further, in a case of not being simultaneous, any one of the timings may be earlier.

Note that, in the exemplary embodiment described above, the suction force of the suction mechanism 50 is changed while the transfer nip load and the fixing nip load are changed, but a form in which the transfer nip load and the fixing nip load are not changed may be adopted. That is, while maintaining the transfer nip load and the fixing nip load constant, the control device 18 may increase the suction force of the suction mechanism 50 from the first suction force to the second suction force larger than the first suction force before the leading end of the paper sheet enters the fixing nip NF and may decrease the suction force of the suction mechanism 50 from the second suction force to the first suction force after the leading end of the paper sheet enters the fixing nip NF. Even in this form, at the timing when the leading end of the paper sheet enters the fixing nip NF, an image quality defect on the portion of the paper sheet positioned at the transfer nip NT is suppressed from occurring.

In addition, when the paper sheet to be printed is relatively thick, the control device 18 may relatively greatly increase the suction force before the leading end of the paper sheet enters the fixing nip NF. That is, in a case where the paper sheet to be printed has a large thickness, the control device 18 may increase the difference amount between the first suction force and the second suction force, compared with a case where the paper sheet to be printed has a small thickness.

In the exemplary embodiments described above, the transfer belt 30 is an example of an image carrier, and the second transfer roller 34 is an example of a transfer member. Note that, as an example of the form of the image forming apparatus 10, one in which the transfer belt 30 is omitted, and a toner image on the photoconductor drum is directly transferred onto a paper sheet P is known. In this form, a transfer nip NT is formed between the photoconductor drum and the transfer roller, and a paper sheet P passes through the transfer nip NT. In this form, the photoconductor drum is an example of the image carrier, and the transfer roller is an example of the transfer member.

Further, the pressure roller 29 and the fixing belt 28 are an example of a pair of fixing members. Note that, in a form in which the fixing device 26 does not include the fixing belt 28, a fixing portion NF is formed between the pressure roller 29 and the fixing roller 27, and the pressure roller 29 and the fixing roller 27 are an example of the pair of fixing members.

In the exemplary embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the exemplary embodiments above, the term “processor” is broad enough to encompass one processor or plural processors in collaboration which are located physically apart from each other but may work cooperatively. The order of operations of the processor is not limited to one described in the exemplary embodiments above, and may be changed.

### Appendix

(((1)))

An image forming apparatus comprising:
an image carrier configured to carry an image on a surface of the image carrier;
a transfer member configured to come into pressure contact with the image carrier to form a transfer nip and configured to transfer the image on the image carrier onto a paper sheet;
a pair of fixing members disposed downstream from the transfer member in a transport path of the paper sheet, configured to come into pressure contact with each other to form a fixing nip, and configured to perform a fixing process on the paper sheet;
a transfer change mechanism configured to move at least one of the image carrier and the transfer member to change a pressure contact state between the image carrier and the transfer member;
a fixing change mechanism configured to move at least one of the pair of fixing members to change a pressure contact state between the pair of fixing members; and
a control unit configured to variably control a transfer nip load at the transfer nip by controlling the transfer change mechanism and variably control a fixing nip load at the fixing nip by controlling the fixing change mechanism, wherein
the control unit, before a leading end of the paper sheet enters the fixing nip, increases the transfer nip load from a first transfer nip load to a second transfer nip load larger than the first transfer nip load and decreases the fixing nip load from a first fixing nip load to a second fixing nip load smaller than the first fixing nip load.
   (((2)))

The image forming apparatus according to (((1))), wherein
the control unit changes at least one of an increase amount that is a difference between the first transfer nip load and the second transfer nip load and a decrease amount that is a difference between the first fixing nip load and the second fixing nip load, based on a type of the paper sheet to be printed.
   (((3)))

The image forming apparatus according to (((2))), wherein
the control unit decreases the increase amount of the transfer nip load in a case where the type of the paper sheet to be printed is coated paper having a coated surface, compared with a case of not being the coated paper.
   (((4)))

The image forming apparatus according to (((2))), wherein
the control unit decreases the decrease amount of the fixing nip load in a case where the type of the paper sheet to be printed is embossed paper having an embossed surface, compared with a case of not being the embossed paper.
   (((5)))

The image forming apparatus according to any one of (((1))) to (((4))), further comprising
a transport device including a suction mechanism configured to generate a negative pressure by sucking air, the transport device being configured to transport the paper sheet while attracting the paper sheet to the transport member by using the suction mechanism, wherein
the transport device is disposed between the transfer nip and the fixing nip, and
the control unit
   increases a suction force of the suction mechanism from a first suction force to a second suction force larger than the first suction force before the leading end of the paper sheet enters the fixing nip,
   decreases the suction force of the suction mechanism from the second suction force to the first suction force after the leading end of the paper sheet enters the fixing nip, and
   increases a different amount between the first suction force and the second suction force in a case where the paper sheet to be printed has a first thickness, compared with a case where the paper sheet to be printed has a second thickness smaller than the first thickness.
      (((6)))

The image forming apparatus according to any one of (((1) to (5))), wherein
the control unit, after the leading end of the paper sheet enters the fixing nip, increases the fixing nip load from the second fixing nip load to the first fixing nip load while maintaining the transfer nip load at the second transfer nip load.
   (((7)))

The image forming apparatus according to (((6))), wherein
the control unit, before a trailing end of the paper sheet exits the transfer nip, decreases the transfer nip load from the second transfer nip load to the first transfer nip load.
   (((8)))

The image forming apparatus according to any one of (((1))) to (((7))), further comprising
a transport device including a suction mechanism configured to generate a negative pressure by sucking air, the transport device being configured to transport the paper sheet while attracting the paper sheet to the transport member by using the suction mechanism, wherein
the transport device is disposed between the transfer nip and the fixing nip, and
the control unit
   increases a suction force of the suction mechanism from a first suction force to a second suction force larger than the first suction force before the leading end of the paper sheet enters the fixing nip and
   decreases the suction force of the suction mechanism from the second suction force to the first suction force after the leading end of the paper sheet enters the fixing nip.
      (((9)))

An image forming apparatus comprising:
an image carrier configured to carry an image on a surface of the image carrier;
a transfer member configured to come into pressure contact with the image carrier to form a transfer nip and configured to transfer the image on the image carrier onto a paper sheet;
a pair of fixing members disposed downstream from the transfer member in a transport path of the paper sheet, configured to come into pressure contact with each other to form a fixing nip, and configured to perform a fixing process on the paper sheet;
a transport device including a suction mechanism configured to generate a negative pressure by sucking air, the transport device being configured to transport the paper sheet while attracting the paper sheet to the transport member by using the suction mechanism; and
a control unit, wherein
the transport device is disposed between the transfer nip and the fixing nip, and
the control unit
   increases a suction force of the suction mechanism from a first suction force to a second suction force larger than the first suction force before a leading end of the paper sheet enters the fixing nip and
   decreases the suction force of the suction mechanism from the second suction force to the first suction force after the leading end of the paper sheet enters the fixing nip.

What is claimed is:

1. An image forming apparatus comprising:
an image carrier configured to carry an image on a surface of the image carrier;
a transfer member configured to come into pressure contact with the image carrier to form a transfer nip and configured to transfer the image on the image carrier onto a paper sheet;
a pair of fixing members disposed downstream from the transfer member in a transport path of the paper sheet, configured to come into pressure contact with each other to form a fixing nip, and configured to perform a fixing process on the paper sheet;
a transfer change mechanism configured to move at least one of the image carrier and the transfer member to change a pressure contact state between the image carrier and the transfer member;
a fixing change mechanism configured to move at least one of the pair of fixing members to change a pressure contact state between the pair of fixing members; and
a control unit configured to variably control a transfer nip load at the transfer nip by controlling the transfer change mechanism and variably control a fixing nip load at the fixing nip by controlling the fixing change mechanism, wherein
the control unit, before a leading end of the paper sheet enters the fixing nip, increases the transfer nip load from a first transfer nip load to a second transfer nip load larger than the first transfer nip load and decreases the fixing nip load from a first fixing nip load to a second fixing nip load smaller than the first fixing nip load.

2. The image forming apparatus according to claim 1, wherein
the control unit changes at least one of an increase amount that is a difference between the first transfer nip load and the second transfer nip load and a decrease amount that is a difference between the first fixing nip load and the second fixing nip load, based on a type of the paper sheet to be printed.

3. The image forming apparatus according to claim 2, wherein
the control unit decreases the increase amount of the transfer nip load in a case where the type of the paper sheet to be printed is coated paper having a coated surface, compared with a case of not being the coated paper.

4. The image forming apparatus according to claim 2, wherein
the control unit decreases the decrease amount of the fixing nip load in a case where the type of the paper sheet to be printed is embossed paper having an embossed surface, compared with a case of not being the embossed paper.

5. The image forming apparatus according to claim 1, further comprising
a transport device including a suction mechanism configured to generate a negative pressure by sucking air, the transport device being configured to transport the paper sheet while attracting the paper sheet to the transport member by using the suction mechanism, wherein
the transport device is disposed between the transfer nip and the fixing nip, and
the control unit
increases a suction force of the suction mechanism from a first suction force to a second suction force larger than the first suction force before the leading end of the paper sheet enters the fixing nip,
decreases the suction force of the suction mechanism from the second suction force to the first suction force after the leading end of the paper sheet enters the fixing nip, and
increases a different amount between the first suction force and the second suction force in a case where the paper sheet to be printed has a first thickness, compared with a case where the paper sheet to be printed has a second thickness smaller than the first thickness.

6. The image forming apparatus according to claim 1, wherein
the control unit, after the leading end of the paper sheet enters the fixing nip, increases the fixing nip load from the second fixing nip load to the first fixing nip load while maintaining the transfer nip load at the second transfer nip load.

7. The image forming apparatus according to claim 6, wherein
the control unit, before a trailing end of the paper sheet exits the transfer nip, decreases the transfer nip load from the second transfer nip load to the first transfer nip load.

8. The image forming apparatus according to claim 6, further comprising
a transport device including a suction mechanism configured to generate a negative pressure by sucking air, the transport device being configured to transport the paper sheet while attracting the paper sheet to the transport member by using the suction mechanism, wherein
the transport device is disposed between the transfer nip and the fixing nip, and
the control unit
increases a suction force of the suction mechanism from a first suction force to a second suction force larger than the first suction force before the leading end of the paper sheet enters the fixing nip and
decreases the suction force of the suction mechanism from the second suction force to the first suction force after the leading end of the paper sheet enters the fixing nip.

9. The image forming apparatus according to claim 7, further comprising
a transport device including a suction mechanism configured to generate a negative pressure by sucking air, the transport device being configured to transport the paper sheet while attracting the paper sheet to the transport member by using the suction mechanism, wherein
the transport device is disposed between the transfer nip and the fixing nip, and
the control unit
increases a suction force of the suction mechanism from a first suction force to a second suction force larger than the first suction force before the leading end of the paper sheet enters the fixing nip and
decreases the suction force of the suction mechanism from the second suction force to the first suction force after the leading end of the paper sheet enters the fixing nip.

10. An image forming apparatus comprising:
an image carrier configured to carry an image on a surface of the image carrier;
a transfer member configured to come into pressure contact with the image carrier to form a transfer nip and configured to transfer the image on the image carrier onto a paper sheet;
a pair of fixing members disposed downstream from the transfer member in a transport path of the paper sheet, configured to come into pressure contact with each other to form a fixing nip, and configured to perform a fixing process on the paper sheet;
a transport device including a suction mechanism configured to generate a negative pressure by sucking air, the transport device being configured to transport the paper sheet while attracting the paper sheet to the transport member by using the suction mechanism; and
a control unit, wherein
the transport device is disposed between the transfer nip and the fixing nip, and
the control unit
increases a suction force of the suction mechanism from a first suction force to a second suction force larger than the first suction force before a leading end of the paper sheet enters the fixing nip and
decreases the suction force of the suction mechanism from the second suction force to the first suction force after the leading end of the paper sheet enters the fixing nip.
